(19) United States
(12) Patent Application Publication
(10) Pub. No.: US 2010/0314494 A1
(43) Pub. Date: Dec. 16, 2010

(54) ADAPTER PLATE FOR AIRPLANE STRUCTURE

(76) Inventors: Michel Gasser, Hegenheim (FR); Peter Grether, Lorrach (DE); Jochen Schramm, Lorrach (DE); Thierry Rietsch, Kappelen (FR)

Correspondence Address: OSTROLENK FABER GERB & SOFFEN, 1180 AVENUE OF THE AMERICAS, NEW YORK, NY, 100368403, US

(21) Appl. No.: 12/482,867

(22) Filed: Jun. 11, 2009

(51) Int. Cl. B64C 1/06

(52) U.S. Cl. 244/131

(57) ABSTRACT

The invention is directed to an adapter plate (1) for interconnecting of a device with an airplane structure. The adapter plate (1) comprises a central beam (2) area extending in a mounted position across at least two longitudinal and/or lateral floor beams (5) of a fuselage of an airplane and at least two stubs (3) arranged at an angle to the central beam area (2) in the general direction of the floor beams. The adapter plate (1) comprises fastening means to interconnect the adapter plate (2) to the floor beams (5) whereby the stubs comprise at least one channel (8) to receive an existing seat track (7) mounted on a floor beam (5).

### FIELD OF THE INVENTION

The invention relates to an adapter plate (pallet) for flexible implementation of load into an existing airframe, i.e. fuselage structure of an airplane.

### BACKGROUND OF THE INVENTION

Modifications to airplane structures are strictly regulated by Aviation Safety Agencies, such as EASA in Europe and the FAA in the USA and according manuals provided by the manufacturer of the vessels.

In airplanes passenger seats and other internal facilities are normally attached to the fuselage structure of an airplane by standardized rail systems which suit as load application means also for all other installations. The rails of said rail systems are attached to or form part of longitudinal or transversal beams of the fuselage positioned underneath the rails. The beams in general are arranged grid like and form part of the overall load carrying structure of the airplane fuselage. Therefore modification to said structure is very critical. Problems which may occur are often related to fatigue and deformation due to local overloading. Other problems may result from local modification of the stiffness and load carrying ability of the structure and thereto related critical influencing of the normal load path. Load implementation in an airplane structure is a critical issue especially when it is necessary to deflect from the foreseen load implementation points.

For the dimensioning of the load carrying structure the critical load is normally related a crash or crash like situation with 9G or 16G. Especially in the passenger area it is therefore necessary that a structure is sufficient stable to withstand critical situations although they occur relatively seldom. The structure must still be as light weight as possible to not obstruct the load carrying capability of the airplane. Additional requirements and criteria which must be fulfilled are related to fatigue aspects.

Especially in passenger cabins of business jets which are normally based on modified commercial airplanes, the need exists that seats and other relatively heavy equipment can be positioned in a flexible manner “offset” to the standardized load application structures, such as the rails and the underneath positioned grid like load carrying structure of the fuselage. Until today pallet like adapters have been used which were then attached to the existing seat track rails. However, these solutions are likely to not withstand the prescribed testing requirements.

If modification or repair is necessary of an airplane structural repair manuals provided by the manufacturer must be consulted. In said repair manuals repair procedures are described which must be fulfilled in line with the regulations of the FAA and the EASA to keep the modification in acceptable scope. The advisory circular No. 25.562-1B of the Federal Aviation Administration (FAA) provides information and guidance regarding acceptable means of compliance with the requirements of 14 CFR part 25 applicable to dynamic testing of seats. The AC provides background and discussion of the reasoning behind the test procedures. It also describes the test facilities and equipment necessary to conduct the tests. Where an adapter (plinth) is used to mount a single seat assembly (whether single or multi-pie place), and the adapter plate is attached to the floor, the adapter plate is considered as part of the seat assembly and should be tested accordingly. Any items of mass attached to the plinth need to be represented and included in the dynamic testing. However, where seats that are mounted on a pallet, for example, multiple seat rows, the pallet is considered part of the floor structure of the airplane based on its size, structural design, and redundancy of attachment. The seats should be attached to the test fixture in a manner representative of the airplane installation. Any items of mass attached to the pallet and not part of the seat structure do not need to be included in the dynamic testing.

US08080027A1 of The Boing Company is directed to a seat track assembly for passenger aircraft to anchor passenger seats to the frame of the aircraft. The seat track assembly has a light weight construction.

One aim of the invention is to provide a solution for the before mentioned problems. A further aim is to provide an improved load application means which does not influence the existing load paths present in the load carrying structure of an airplane in a negative manner.

### SUMMARY OF THE INVENTION

The problem is solved by an adapter plate which acts as a load carrying structure interconnectable to an existing load carrying structure of the airplane fuselage without negative influence of the overall static concept. The adapter plate acts as an adapter between a device, such as one or more seats or another installation and the load carrying structure of the fuselage. The device is attached to the adapter plate only and/or to more than one adapter plate and/or the existing structure and an adapter plate. In general the adapter plate when interconnected to the load carrying structure of the airplane functionally forms part of said load carrying structure and not of the installation. In general an adapter plate according to the herein discussed invention may be attached reversible to the longitudinal and/or transversal floor beams of the fuselage. Thereby reversible modifications are possible without negative impact of the existing structure.

In certain cases it is foreseen that the fixation of the adapter plate has a certain degree of freedom in a specific direction with the aim that at least one end can be displaced under certain conditions. Thereby the adapter plate does not influence the overall load path in a negative manner but still is capable to transfer the load applied to it. In one embodiment this is achieved by holes having an oblong cross-section (oblong holes). The inside of the oblong holes may be plated to avoid damage of the surface.

E.g. in that the adapter plate is mount with a certain clearance in transverse direction (y-s direction, perpendicular to length of fuselage) it can be avoided that forces are transmitted to a seat track in said direction the adapter plate thereby does not affect aircraft stiffness in transverse. Additional clearance may be foreseen if necessary. In addition, the pallet itself, due to its short length and dimensions compared to the whole aircraft structure, can not be considered as a load path for the fuselage structure loads in said direction. Thereby pallet installation does not modify the behavior of aircraft structure along transverse direction in a negative manner.

In a preferred embodiment the invention is directed to an adapter plate for an airplane structure comprising a central beam area extending in a mounted position across at least two longitudinal and/or lateral floor beams of a grid like beams structure of a fuselage. At least two stubs arranged at an angle (in general in the range of 90°) to the central beam area in the general direction of the crossed floor beams. The stubs comprise fastening means to interconnect the adapter plate to the floor beams. Preferably the adapter plate can be attached to and removed from the airplane structure without damage. In a preferred embodiment the stubs comprise at least one channel to receive an existing seat track mounted on a floor beam. Preferably no load is applied to the seat track. Instead the load is directly applied to the bellow structure of the fuselage. If appropriate the adapter plate and the seat track can be attached by the same bolts. For improved load application without negative step in the stiffness of the structure the stubs laterally may extend above the central beam area in at least one direction. Depending on the field of application the adapter plate has in a top view an in general C- or E-shaped ground view or a symmetric arrangement of the stubs with respect to the central beam area. The central beam area arranged between two stubs normally has a reduced wall thickness compared to the stubs. The load applied to the intermediate areas is collected and transferred to the stubs which then distribute the load into the fuselage structure. In a preferred embodiment the adapter plate comprises holes arranged corresponding (co-centric) to existing screw holes of the fuselage structure to attach the adapter plate to the fuselage structure. The adapter plate may be designed compatible with gussets foreseen to be arranged underneath a floor beam opposite to the adapter plate whereby the floor beam is encompassed by the floor beam and the gussets.

To avoid negative impact of existing load paths the fastening means at least partially are holes with an oblong cross section in general extending in the direction of the central beam area. In a preferred embodiment the central beam area has in longitudinal direction an in general U-shaped cross-section. The arms of the U-shaped cross-section may comprise fastening means to fasten at least one floor panel. By the herein described adapter plate it becomes possible to successfully withstand dynamic testing of e.g. a seat installation at 16 g dynamic peak load test. A further advantage is that no considerable fatigue load is introduced in the seat track beams.

The adapter plate according to the invention is normally made out of lightweight metal such as aluminum or titan or alloys thereof. The adapter plate is normally made in an integral manner by grinding. Other methods may be appropriate. If appropriate the adapter plate can be made out of several parts.

### BRIEF DESCRIPTION OF THE DRAWINGS

Features and aspects of the invention will be readily understood with reference to the following detailed description taken in conjunction with the accompanying drawings, in which like or similar numbers are used throughout, and in which:

FIG. 1 shows a first embodiment of an adapter plate in a top view;

FIG. 2 a cross section through a first adapter plate;

FIG. 3 a cross section through a second adapter plate;

FIG. 4 a cross section through a third adapter plate;

FIG. 5 A second embodiment of an adapter plate in a perspective view from above;

FIG. 6 The adapter plate according to FIG. 5 in a perspective view from bellow;

FIG. 7 The adapter plate according to FIG. 5 in a top view;

FIG. 8 Detail A of FIG. 7;

FIG. 9 The adapter plate according to FIG. 5 in a front view;

FIG. 10 A third embodiment of an adapter plate in a perspective view from above;

FIG. 11 The adapter plate according to FIG. 10 in a perspective view from bellow;

FIG. 12 The adapter plate according to FIG. 10 in a top view;

FIG. 13 Detail B of FIG. 12;

FIG. 14 The adapter plate according to FIG. 10 in a front view;

FIG. 15 A fourth embodiment of an adapter plate in a perspective view from above;

FIG. 16 The adapter plate according to FIG. 15 in a perspective view from bellow;

FIG. 17 The adapter plate according to FIG. 15 in a top view;

FIG. 18 The adapter plate according to FIG. 15 in a front view.

### DESCRIPTION OF EMBODIMENTS OF THE INVENTION

A better understanding of the present invention may be obtained by the present detailed description which, when examined in connection with the accompanying drawings, sets forth embodiments of the inventions described herein. It should be understood that corresponding elements in the various figures are generally identified with corresponding reference numbers.

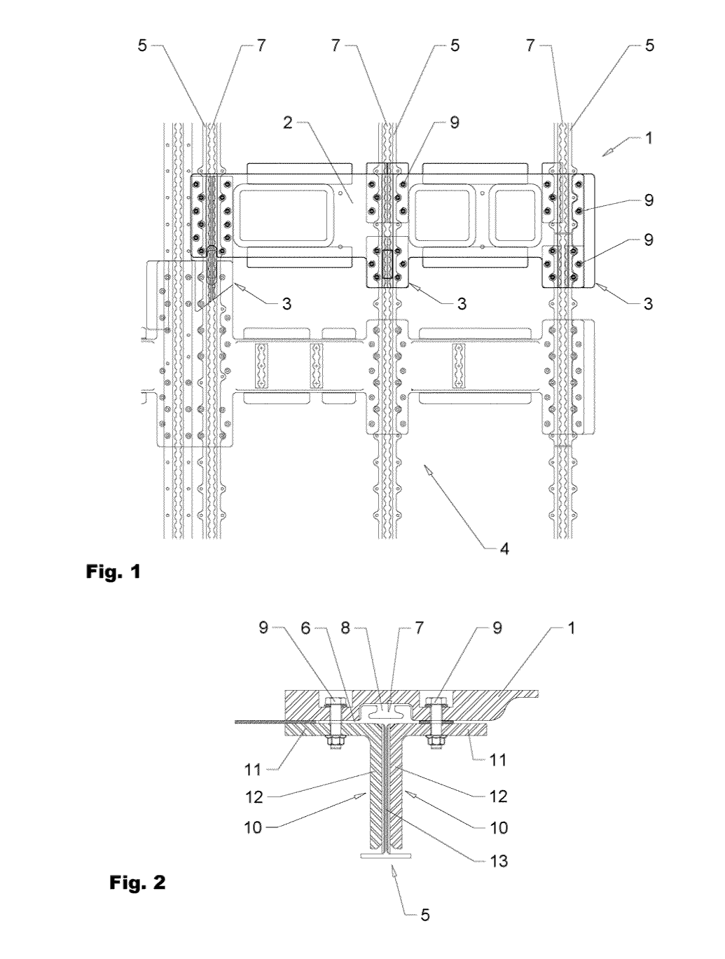

FIG. 1 shows a first adapter plate 1 according to the invention in a top view and interconnected to a grid like floor structure 4 consisting out of longitudinal and transversal floor beams 5. The adapter plate 1 is foreseen to be interconnected by a seat or other equipment which needs to be fixed to the existing structure of an airplane. The seat or device is attached to the adapter plate only and/or to more than one adapter plate and/or the existing structure and an adapter plate. The longitudinal floor beams 5 are arranged in the length direction (x-direction) of an airplane (neither the floor transversal floor beams not the airplane are shown in detail). Chords 6 of the longitudinal floor beams 5 are equipped with seat track rails 7 designed for the attachment of passenger seats or other equipment (both not shown).

The adapter plate 1 comprises a central beam section 2 and stubs 3 which in the shown embodiment laterally extend above the central beam section 2. The stubs 3 are mainly responsible for the implementation of the load applied to the central beam section into the floor beams 5.

FIGS. 2, 3 and 4 are showing in sectional views how an adapter plate 1 according to the present invention is preferably affixed to a floor beam 5 comprising a seat track rail 7. The herein shown adapter plate 1 comprises channels 8 to receive and encompass the existing seat track rails 7. The adapter plate 1 is preferably affixed to the existing structure of the fuselage by gussets 10 arranged with respect to the adapter plate 1 at the opposite site of the floor beam 7.

The adapter plate 1 and the gussets 10 are preferably attached to each other and the encompassed structure by bolts 9 which are arranged corresponding to existing holes 12, 13 of the fuselage structure. The existing bolts or rivets are therefore removed. If necessary additional holes and bolts can be foreseen. In the herein described example the bolts 9 extend across the chord 6 of the longitudinal floor beams 5 adjacent to the seat track rails 7 whereby no load is implement in the seat track rails 7. One advantage resulting there from can be seen in the functional fusion of the adapter plate 1 and the existing floor structure 4 of the aircraft. In addition the structure is in line with the repair manuals of the FAA and the EASA capable to withstand standard test requirements according to the FAA and the

As it can be seen from the sectional views according to FIGS. 2, 3 and 4 the gussets 10 comprise a first and a second leg 11, 12 which in a mounted position extend along the chord 6 in horizontal and along a bar 13 of the floor beam 5 in vertical direction. Thereby it is achieved that the load is applied gently to the surrounding structure without negative impact. In addition it is possible to remove the added structure without remaining changes.

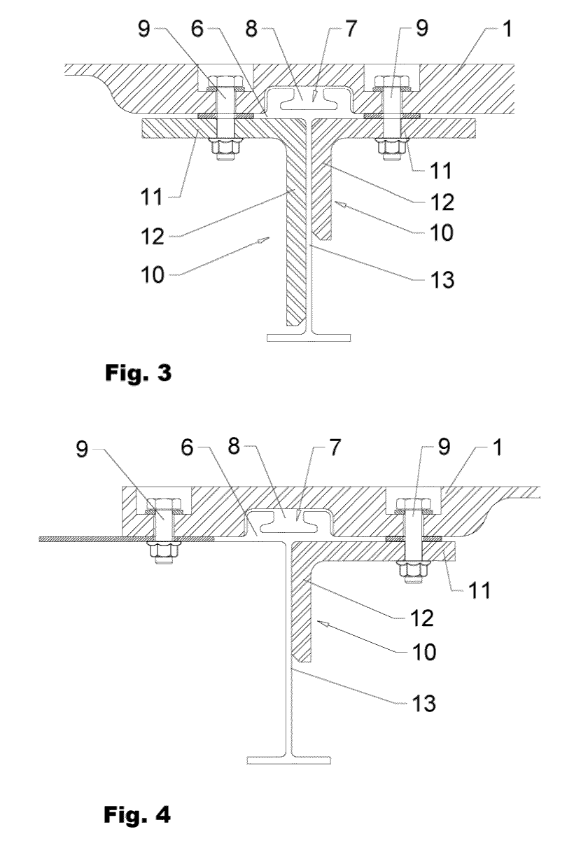

Depending on the field of application the affixation may change. In the embodiment according to FIG. 2 two opposite gussets 10 laterally support the bar 13. In the embodiment according to FIG. 3 the gussets 10 have different lengths and in the embodiment according to FIG. 4 the only one gusset 10 is present.

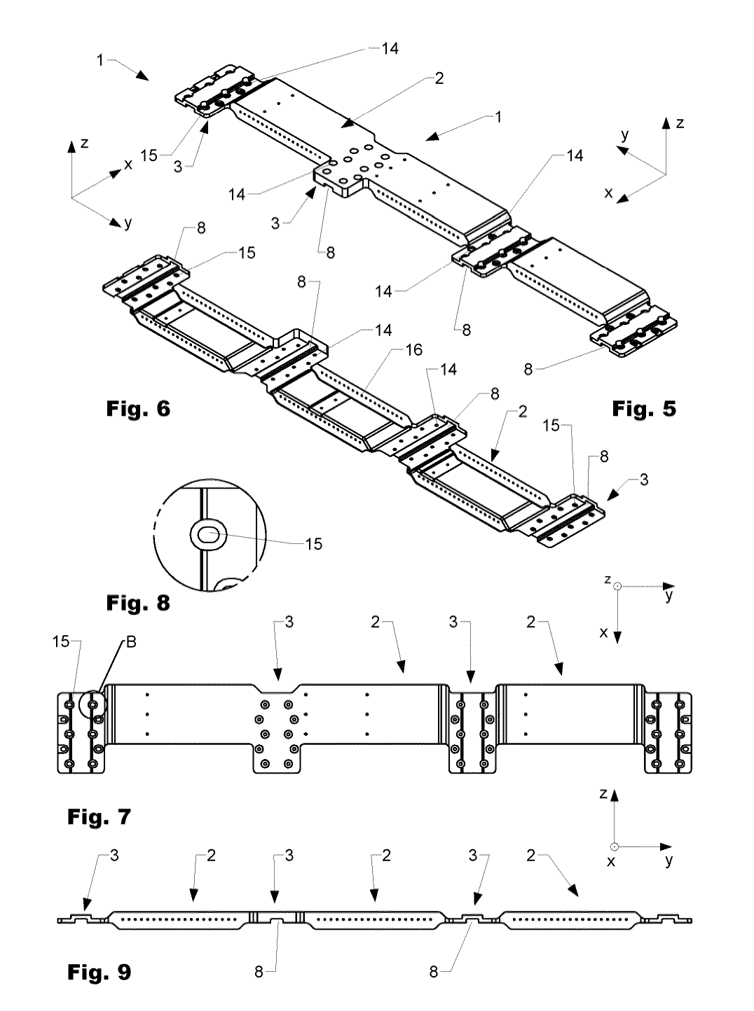

FIGS. 5 through 9 show a second embodiment of an adapter plate 2 in a perspective view from top (FIG. 5) and from bottom (FIG. 6). FIG. 7 is showing the adapter plate in a top view and FIG. 9 in a front view. FIG. 8 is showing detail A of FIG. 7.

The shown embodiment comprises a central beam section 2 which is designed to in a mounted position extend across four in general parallel floor beams of a fuselage structure of an airplane (not visible). At the position of the floor beams the adapter plate 1 comprises stubs 3 by which the adapter plate 1 can be attached to the floor beams. Depending on the size and the functionality of the individual floor beams the stubs 3 have an individual design. Each stub 3 comprises a channel 8 arranged in a transversal direction with respect to the floor beams suitable to receive and encompass existing seat track rails mounted on top of the floor beams (see FIGS. 2 through 5).

The adapter plate 1 can extend over 2 or more floor beams. To reduce influence onto existing load paths it is possible to foresee holes with oblong cross sections whereby a certain adjustment remains available. In FIG. 8 which shows detail A of FIG. 7 a hole with an oblong cross section is shown.

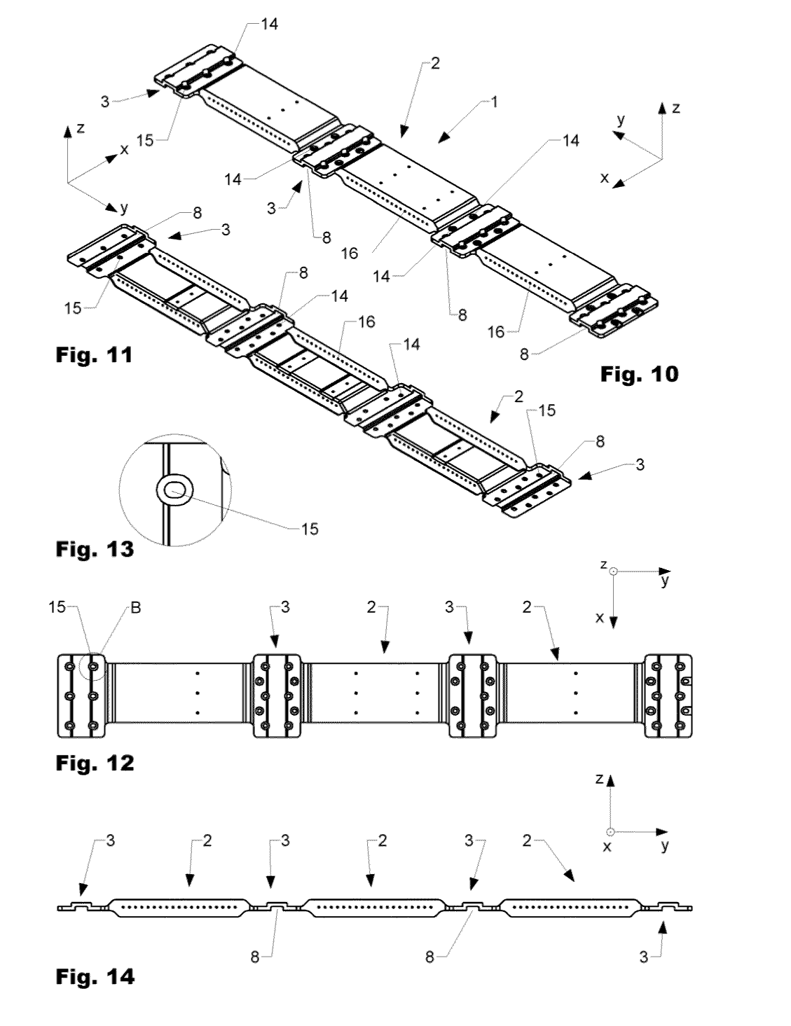

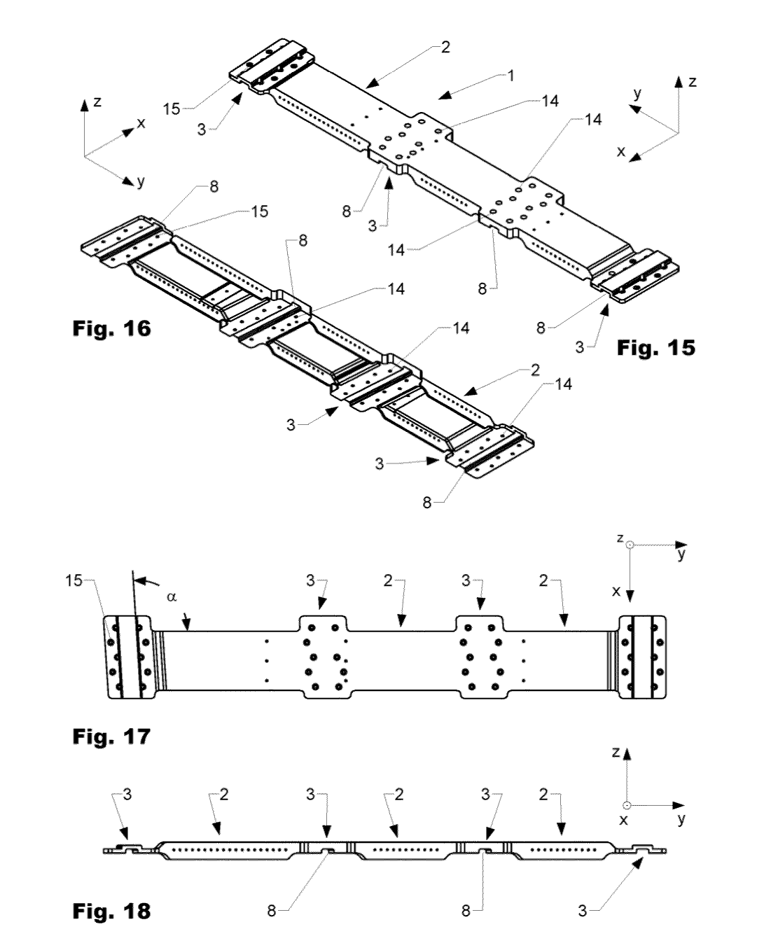

FIGS. 10 through 14 is showing a third and FIGS. 15 through 18 is showing a fourth embodiment of an adapter plate 1 in a perspective view from top (FIGS. 10 and 15) and from bottom (FIGS. 11 and 16). FIGS. 12 and 17 are showing the adapter plates 1 in a top view and FIGS. 14 and 18 in a front view. FIG. 13 is showing detail B of FIG. 12

The adapter plates 1 according to the FIGS. 10 through 18 in general correspond to the second embodiment according to FIGS. 5 through 9. Therefore, with respect to the general description reference is made to said Figures. Similar features are carrying corresponding reference signs. Although all examples are showing adapter plates 1 with a lateral extension across three floor beams it is possible to realize adapter plates which reach across a different number of floor beams.

In the embodiment according to FIGS. 15 through 18 stubs 3 are arranged at an angle a with respect to the lateral extension of the central beam part 2. The respective channels 8 are arranged at the same direction.

The adapter plates 1 according to FIGS. 10 through 18 are in general similar with respect to their functional behavior. The central beam sections are having an in general U-shaped cross section facing downwards and thereby having a flat top surface. Laterally fixing means 16 to affix floor panels or other equipment can be foreseen.

Depending on the field of application the stubs 3 can have different lateral extensions or even be set back with respect to the central beam section 2. In general the stubs 3 are relevant for optimized load application into the existing fuselage structure. Otherwise the performance may not be satisfying.

The stubs 3 can vary not only in lateral extension but also with respect to their thickness. Stubs 3 which carry fewer loads can be reduced in their thickness. By changes to the lateral extension it is possible to flexibly adapt the adapter plate 3 to all kind of situations.

### REFERENCE SIGNS

1 Adapter Plate (Pallet)

2 Central beam section

3 Stubs (for interaction with floor beams)

4 Floor structure

5 Floor beam (longitudinal)

6 Chord

7 Seat track rail

8 Channel to receive seat track rail

9 Bolt

10 Gusset

11 First leg (horizontal)

12 Second leg (vertical)

13 Bar

14 Holes (to receive fixation means)

15 Oblong Holes (to receive fixation means

16 Fixing means e.g. to attach floor panels

What is claimed is:

1. Adapter plate for interconnecting of a device with an airplane structure comprising a central beam area extending in a mounted position across at least two longitudinal and/or lateral floor beams of a fuselage of an airplane and at least two stubs arranged at an angle to the central beam area in the direction of the floor beams comprising fastening means to interconnect the adapter plate to the floor beams whereby the stubs comprise at least one channel to receive an existing seat track mounted on a floor beam.

2. The adapter plate according to claim 1, wherein at least one stub laterally protrudes above the central beam area.

3. The adapter plate according to claim 1, wherein the adapter plate in a top view is in general C- or E-shaped.

4. The adapter plate according to claim 1, wherein at least one stub is arranged perpendicular to the central beam area.

5. The adapter plate according to claim 1, wherein the central beam area arranged between two stubs has a reduced wall thickness compared to the stubs.

6. The adapter plate according to claim 1, wherein the fastening means to interconnect the adapter plate to the fuselage structure are holes arranged corresponding to existing screw holes of the fuselage structure.

7. The adapter plate according to claim 1, wherein the adapter plate is compatible with gussets foreseen to be arranged underneath a floor beam opposite to the adapter plate whereby the floor beam is encompassed by the floor beam and the gussets.

8. The adapter plate according to claim 1, wherein the fastening means at least partially are holes with an oblong cross section extending in the direction of the central beam area.

9. The adapter plate according to claim 1, wherein the central beam area has in longitudinal direction an in general U-shaped cross-section.

10. The adapter plate according to claim 9, wherein the arms of the U-shaped cross-section comprise fastening means to fasten at least one floor panel.

11. The adapter plate according to claim 1, wherein the adapter plate comprises means to fasten a seat and/or another cabin element.
